(19) United States
(12) Patent Application Publication
(10) Pub. No.: US 2007/0115240 A1
(43) Pub. Date: May 24, 2007

(54) DISPLAY DEVICE AND DRIVING METHOD OF THE SAME

(76) Inventors: Yukio Tanaka, Kanazawa-shi (JP); Tetsuo Fukami, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/555,929

(22) Filed: Nov. 2, 2006

(30) Foreign Application Priority Data
Nov. 22, 2005 (JP) 2005-337279

(51) Int. Cl. G09G 3/36

(52) U.S. Cl. 345/98

(57) ABSTRACT

A display device includes a plurality of rows of display pixels, a driver circuit which drives the plurality of rows of display pixels in units of a predetermined number of rows, and a control circuit which controls the driver circuit in such a manner as to alternately execute non-video signal write for simultaneously driving the predetermined number of rows of display pixels and writing non-video signals, and video signal write for successively driving the predetermined number of rows of display pixels and writing video signals. The control circuit assigns, in the video signal write, a first period to the row of display pixels which are first driven, and a second period to each of the other rows of display pixels, and sets the first period to be longer than the second period.

### CROSS-REFERENCE TO RELATED APPLICATIONS

This application is based upon and claims the benefit of priority from prior Japanese Patent Application No. 2005-337279, field Nov. 22, 2005, the entire contents of which are incorporated herein by reference.

### BACKGROUND OF THE INVENTION

1. Field of the Invention

The present invention relates generally to a display device, and more particularly to a display device which is driven in an active matrix driving scheme, and a driving method thereof.

2. Description of the Related Art

In recent years, products which incorporate liquid crystal display devices as display devices, such as small-sized game machines, portable PCs and mobile phones, have been quickly gaining in popularity.

In general, a liquid crystal display panel of the liquid crystal display device is configured such that a liquid crystal layer is held between an array substrate and a counter-substrate. In the case where the liquid crystal display panel is of an active matrix type, the array substrate includes a plurality of pixel electrodes which are arranged substantially in a matrix, a plurality of gate lines which are disposed along the rows of the pixel electrodes, a plurality of source lines which are disposed along the columns of the pixel electrodes, and a plurality of switching elements which are disposed near intersections of the gate lines and source lines.

The respective gate lines are connected to a gate driver which drives the gate lines. The respective source lines are connected to a source driver which drives the source lines. The gate driver and source driver are controlled by a control circuit. Each of the switching elements is composed of, e.g. a thin-film transistor (TFT). When the associated gate line is driven by the gate driver, the switching element is rendered conductive, thereby applying a pixel voltage, which is set on the associated source line by the source driver, to the associated pixel electrode.

The counter-substrate is provided with a counter-electrode which is opposed to the plural pixel electrodes disposed on the array substrate. A display pixel is constituted by a pair of each pixel electrode and the common electrode, together with a pixel region which is a part of the liquid crystal layer that is interposed between these paired electrodes. A driving voltage for the pixel is a difference between a pixel voltage, which is applied to the pixel electrode, and a common voltage which is applied to the counter-electrode. Even after the switching element is turned off, the driving voltage is held between the pixel electrode and the counter-electrode.

Orientation of liquid crystal molecules in the pixel region is set by an electric field which corresponds to the driving voltage. Thereby, the transmittance of the pixel is controlled. The polarity reversal of the driving voltage is executed, for example, by cyclically reversing the polarity of the pixel voltage in relation to the common voltage. Thus, the direction of electric field is reversed to prevent non-uniform distribution of liquid crystal molecules in the liquid crystal layer.

In the field of large-sized liquid crystal TVs, liquid crystal display panels of an OCB (Optically Compensated Bend) mode, which has a high liquid crystal responsivity that is needed for moving image display, have begun to be adopted. This liquid crystal display panel performs a display operation by transitioning the alignment state of liquid crystal molecules from a splay alignment to a bend alignment in advance. In this case, if a voltage-off state or a nearly voltage-off state continues for a long time, the bend alignment reversely transitions to the splay alignment. In this type of liquid crystal display panel, black-insertion driving is used in order to prevent the reverse transition to the splay alignment (Jpn. Pat. Appln. KOKAI Publication No. 2002-328654).

When the black insertion driving is performed, two write operations, that is, a black insertion write operation and a video signal write operation, are executed in 1 frame period with respect to each pixel electrode. Specifically, after the black insertion write is executed, the signal line potential changes from a black level to a voltage level of the video signal. At this time, if the time constant of the signal line is high, the signal line potential fails to reach a target potential in a video signal write period, which immediately follows the black insertion write. As a result, in some cases, a write error occurs and a display image deteriorates.

### BRIEF SUMMARY OF THE INVENTION

The present invention has been made in consideration of the above-described problem, and the object of the invention is to provide a display device which displays a high-quality display image, and a driving method of the display device.

According to a first aspect of the present invention, there is provided a display device comprising: a plurality of rows of display pixels; a driver circuit which drives the plurality of rows of display pixels in units of a predetermined number of rows; and a control circuit which controls the driver circuit in such a manner as to alternately execute non-video signal write for simultaneously driving the predetermined number of rows of display pixels and writing non-video signals, and video signal write for successively driving the predetermined number of rows of display pixels and writing video signals, wherein the control circuit assigns, in the video signal write, a first period to the row of display pixels which are first driven, and a second period to each of the other rows of display pixels, and sets the first period to be longer than the second period.

According to a second aspect of the present invention, there is provided a driving method of a display device including a plurality of rows of display pixels; a driver circuit which drives the plurality of rows of display pixels in units of a predetermined number of rows; and a control circuit which controls the driver circuit in such a manner as to alternately execute non-video signal write for simultaneously driving the predetermined number of rows of display pixels and writing non-video signals, and video signal write for successively driving the predetermined number of rows of display pixels and writing video signals, the method comprising: causing the control circuit to assign, in the video signal write, a first period to the row of display pixels which are first driven, and a second period to each of the other rows of display pixels; and causing the control circuit to set the first period to be longer than the second period.

According to the present invention, the occurrence of a signal write error in a display pixel is suppressed in a video signal write period which immediately follows black insertion write, thereby providing a display device which displays a high-quality display image, and a driving method of the display device.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a liquid crystal display panel of a liquid crystal display device according to a first embodiment of the present invention;

FIG. 2 is a timing chart illustrating an example of the operation of the liquid crystal display device shown in FIG. 1;

FIG. 3 is a view for describing an example of the structure of the liquid crystal display panel shown in FIG. 1;

FIG. 4 is a diagram illustrating the operation of the structure of the liquid crystal display device shown in FIG. 3;

FIG. 5 schematically shows a liquid crystal display panel of a liquid crystal display device according to a second embodiment of the present invention;

FIG. 6 shows an example of the structure of a multiplexer shown in FIG. 5;

FIG. 7 shows another example of the structure of the multiplexer shown in FIG. 5;

FIG. 8 is a timing chart illustrating an example of the operation of the liquid crystal display device shown in FIG. 5;

FIG. 9 is a view for describing an example of the structure of the liquid crystal display panel shown in FIG. 5; and

FIG. 10 is a diagram illustrating the operation of the structure of the liquid crystal display device shown in FIG. 9.

### DETAILED DESCRIPTION OF THE INVENTION

A display device according to a first embodiment of the present invention will now be described with reference to the accompanying drawings.

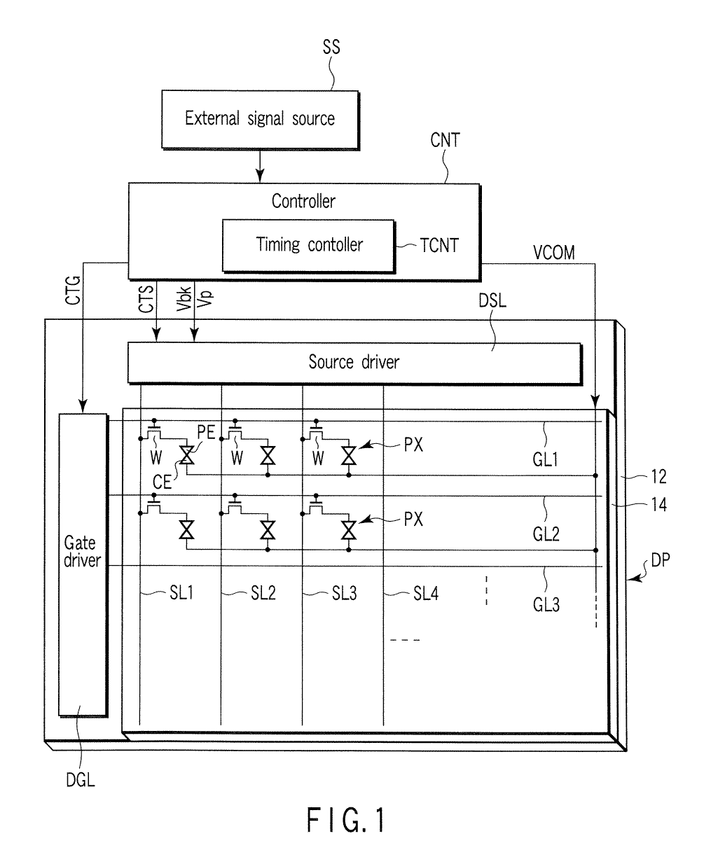

The display device according to the embodiment is a liquid crystal display device which includes a liquid crystal display panel DP. The liquid crystal display panel DP, as shown in FIG. 1, includes an array substrate 12 and a counter-substrate 14, which are a pair of electrode substrates, and a liquid crystal layer (not shown) which is held between the array substrate 12 and counter-substrate 14.

The liquid crystal layer includes, as a liquid crystal material, an OCB liquid crystal which is transitioned in advance from a splay alignment to a bend alignment, for example, in order to perform a normally white display operation. Reverse transition from the bend alignment to the splay alignment is prevented by cyclically applying a driving voltage, which corresponds to black display, to the liquid crystal layer.

The array substrate 12 includes a plurality of pixel electrodes PE which are arrayed substantially in a matrix on a transparent insulating substrate such as a glass substrate; a plurality of gate lines GL (GL1 to GLm) which are arranged along the rows of the plural pixel electrodes PE; a plurality of source lines SL (SL1 to SLn) which are arranged along the columns of the plural pixel electrodes PE; and a plurality of pixel switches W which are disposed near intersections of the gate lines GL and source lines SL and are rendered conductive between the associated source lines SL and associated pixel electrodes PE when the pixel switches W are driven via the associated gate lines GL.

Each of the pixel switches W is composed of, e.g. a thin-film transistor. The thin-film transistor has a gate electrode connected to the gate line GL and a source-drain path connected between the source line SL and the pixel electrode PE.

The counter-substrate 14 includes a counter-electrode CE which is disposed to be opposed to the plural pixel electrodes PE. Each of the pixel electrodes PE and the counter-electrode CE is formed of a transparent electrode material such as ITO. The pixel electrodes PE and the counter-electrode CE are covered with alignment films (not shown) which are subjected to rubbing treatment.

Each of display pixels PX is constituted by each of the pixel electrodes PE and the counter-electrode CE together with a pixel region which is a part of the liquid crystal layer that is controlled to have an orientation of liquid crystal molecules corresponding to an electric field generated from the pixel electrode PE and counter-electrode CE. The display pixels PX are arrayed substantially in a matrix at positions of intersection between the source lines SL and the gate lines GL. In other words, a plurality of rows of display pixels PX are arranged along the plural gate lines. In this embodiment, the plurality of rows of display pixels PX are OCB liquid crystal pixels.

The liquid crystal display device includes a driver circuit which drives the plural rows of display pixels PX in units of a predetermined number of rows; and a controller CNT which controls the driver circuit so as to alternately execute non-video signal write for simultaneously driving the predetermined number of rows of display pixels PX and writing non-video signals Vbk and video signal write for successively driving the predetermined number of rows of display pixels PX and writing video signals Vp. A sync signal, etc. are input from an external signal source SS to the controller CNT.

The driver circuit includes a gate driver DGL which is disposed on the array substrate 12 and is connected to the plural gate lines GL; and a source driver DSL which is connected to the plural source lines SL. The source driver DSL includes an output buffer Bf which outputs the non-video signals Vbk and video signals Vp to the plural source lines SL.

The gate driver DGL successively drives the plural gate lines GL so as to turn on the pixel switches W on a row-by-row basis. The source driver DSL outputs pixel voltages Vs from the output buffer Bf to the plural source lines SL in a period in which the pixel switches W of each row are turned on by the driving of the associated gate line GL.

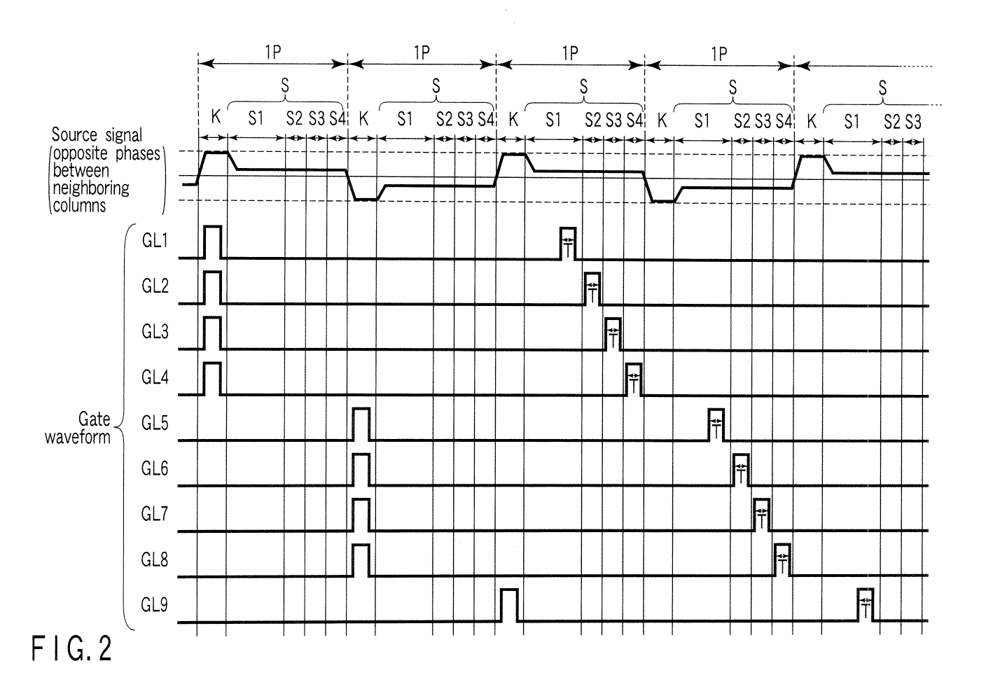

As is shown in FIG. 2, the gate driver DGL and source driver DSL are configured to repeat the following operation. Specifically, in a non-video signal write period K, a plurality of gate lines GL are selectively driven so as to simultaneously select a predetermined number of rows of display pixels PX (in this embodiment four rows of display pixels PX), and non-video signals Vbk for the predetermined number of rows of display pixels PX are output as pixel voltages Vs to the plural source lines SL.

In a video signal write period S that follows the non-video signal write period K, the gate lines GL are selectively driven so as to successively select the predetermined number of rows of display pixels PX (in this embodiment four rows of display pixels PX), and video signals Vp for the predetermined number of rows of display pixels PX are output as pixel voltages Vs to the plural source lines SL.

At this time, the controller CNT, which controls the gate driver DGL and source driver DSL, assigns a first period S1 of the video signal write period S to the row of display pixels which are first driven, and successively assign second periods S2 to S4 to the other rows of display pixels. The first period S1 is set to be longer than the second period, S2 to S4.

In the video signal write period S, the predetermined number of rows of display pixels PX are driven in units of a predetermined time length T in the first and second periods S1 to S4 which are assigned to these display pixels PX.

The controller CNT is configured to execute an initializing process for transitioning liquid crystal molecules from a splay alignment to a bend alignment by varying a common voltage Vcom at the time of power-on and applying a relatively high driving voltage to the liquid crystal layer.

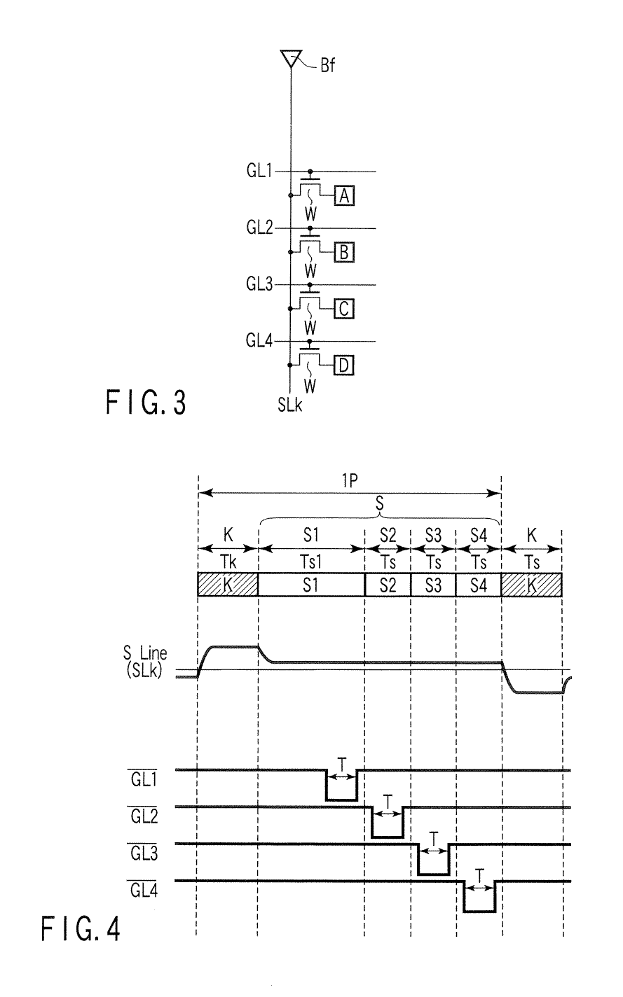

In an example shown in FIG. 3, display pixels A, B, C, D are disposed at positions of intersection between the gate lines GLl to GL4 and the source line SLk. In this case, the gate driver DGL turns on the pixel switches W which are connected to the gate lines GL1 to GL4, and the source driver DSL outputs pixel voltages Vs from the output buffer Bf to the source line SLk during a period in which the pixel switches W of the respective rows are turned on by the driving of the associated gate line GL.

AT this time, the gate driver DGL and source driver DSL are controlled by the controller CNT. The controller CNT includes a timing controller TCNT which controls the operation timing of the gate driver DGL and source driver DSL in each period of driving of the predetermined number of rows of display pixels.

As is shown in FIG. 4, in the video signal write period S, the timing controller TCNT selectively drives the plural gate lines GL so as to successively select the gate lines GL1 to GL4, and outputs video signals Vp, which correspond to the display pixels A, B, C and D, to the source line SLk as pixel voltages Vs.

In this case, the timing controller TCNT sets the time width Ts1 of the first period S1 of the video signal write period S to be greater than the time width Ts of each of the second periods S2 to S4. Preferably, the time width Ts1 of the first period S1 should be set to be about 1.5 times greater than the time width Ts of each of the second periods S2 to S4. In the present embodiment, the timing controller TCNT is configured to set the time width Ts1 of the first period S1 to be about 2 times greater than the time width Ts of each of the second periods S2 to S4.

In addition, as shown in FIG. 4, the timing controller TCNT is configured to drive the display pixels A, B, C and D, which are connected to the gate lines GL1 to GL4, in units of a predetermined time length T in the first and second periods S1 to S4 of the video signal write period S, which are assigned to the display pixels A, B, C and D. In short, in the video signal write period S, the driving time lengths T, in which the gate lines GL1 to GL4 are successively driven, are set to be equal.

In the example shown in FIG. 4, the non-video signal Vbk is applied to the source line SLk in a period prior to the first period S1. If the time constant of the source line SL is large, the potential of the source line SLk does not quickly reach a desired potential even after the end of the non-video signal write period K.

In the video signal write period S, if the gate lines GL1 to GL4 are successively driven by setting the first period S1 and the second period, S2 to S4, to be equal, there may be such a case that the potential of the source line SLk is yet to reach a desired value at the timing when the gate line GL1 is driven. Consequently, such a write error may occur that a potential value different from a target potential is written in the display pixel A in which the video signal Vp is written at the timing when the gate line GL1 is driven.

By contrast, if the first period S1 is set to be longer than the second period, S2 to S4, as described above, even if the time constant of the source line SL is large, it is possible to write the video signal Vp in the associated display pixel A by driving the gate line GL1 after the source line potential reaches the target potential within the first period S1. Thus, the voltage that is written in the display pixel A has a value of the target potential, and no write error occurs. Therefore, according to the liquid crystal display device of the present embodiment, there can be provided a display device which displays a high-quality display image.

Next, a driving method of the above-described liquid crystal display device is described. In the description of this embodiment, it is assumed that video signals Vp corresponding to all display pixels have equal intermediate gradation levels.

As is shown in FIG. 1, the controller CNT outputs a control signal CTG, which is generated on the basis of a sync signal that is input from the external signal source SS, to the gate driver DGL. The controller CNT also outputs to the source driver DSL a control signal CTS, which is generated on the basis of the sync signal that is input from the external signal source SS, and a video signal Vp or a black-insertion non-video signal Vbk, which is generated on the basis of a video signal that is input from the external signal source SS. Further, the controller CNT outputs a common voltage Vcom, which is to be applied to the counter-electrode CE, to the counter-electrode CE of the counter-substrate 14.

At this time, as shown in FIG. 2, the non-video signal write period K and video signal write period S are set in the timing controller TCNT on the basis of the sync signal that is input from the external signal source SS.

The timing controller TCNT assigns a first period S1 to the row of display pixels PX, which are to be first driven in the video signal write period S, and assigns second periods S2 to S4 to the other rows of display pixels PX, respectively. The timing controller TCNT sets the first period S1 to be longer than each of the second periods S2 to S4.

The timing controller TCNT controls the gate driver DGL and source driver DSL so that a predetermined number of rows of display pixels PX are driven in units of a predetermined time length T in the first and second periods S1 to S4 of the video signal write period S, which are assigned to these pixels PX.

In the present embodiment, as shown in FIG. 2, the gate driver DGL selectively drives four gate lines GL so as to simultaneously select four rows of display pixel PX in the non-video signal write period K. The source driver DSL outputs non-video signals Vbk, which correspond to the four rows of display pixels PX, as pixel voltages Vs to the plural source lines SL. The pixel voltages Vs are applied to the display pixels PX of the selected rows via the associated pixel switches w.

In the video signal write period S that follows the non-video signal write period K, the gate driver DGL selectively drives the plural gate lines GL so as to successively select the four rows of display pixels PX. The source driver DSL successively outputs video signals Vp, which correspond to the four rows of display pixels PX, as pixel voltages Vs to the plural source lines SL. These pixel voltages Vs are applied to the display pixels PX of the selected rows via the associated pixel switches W.

The gate driver DGL and source driver DSL repeat this operation in every basic cycle (1P) which comprises the non-video signal write period K and video signal write period S. In this embodiment, the driving timing is set such that the basic cycle (1P) is defined by dividing a time period corresponding to 4 horizontal cycles into five periods. Specifically, the basic cycle (1P) includes the non-video signal write period K and the video signal write period S which comprises the first and second periods S1 to S4.

In the case of a column-inversion driving scheme, the pixel voltages Vs for all the display pixels PX are reversed in polarity on a pixel column by pixel column basis. In the case of a frame-inversion driving scheme, the pixel voltages Vs are reversed in polarity on a frame-by-frame basis.

As described above, the non-video signal write period K is used to write the non-video signals Vbk in the four rows of display pixels PX, and the video signal write period S is used to write video signals Vp in the four rows of display pixels PX.

In this case, the timing controller CNT controls the gate driver DGL and source driver DSL such that the time width of the first period S1 of the video signal write period S, which immediately follows the non-video signal write period K, becomes greater than the time width of the second period, S2 to S4, of the video signal write period S. In other words, the controller CNT controls the gate driver DGL so as to select an associated one of the gate lines GL after the potentials of the plural source lines SL reach the value of the video signals, which are written in the display pixels PX, in the first period S1 that follows the non-video signal write period K.

The timing controller TCNT controls the gate driver DGL and source driver DSL such that the time width Ts1 of the first period S1, which is immediately after the non-video signal write period K, is set to be about 1.5 times greater than the time width Ts of each of the second periods S2 to S4. In the present embodiment, the timing controller TCNT sets the time width Ts1 of the first period S1, which immediately follows the non-video signal write period K, to be about 2 times greater than the time width Ts of each of the second periods S2 to S4.

The non-video signal write period K may be determined within such a range that no problem arises in the non-video signal write for preventing reverse transition. The time widths of the non-video signal write period K, the first period S1 of the video signal write period S and the second periods S2 to S4 of the video signal write period S may be determined, for example, in the following method.

To begin with, a minimum necessary non-video signal write period K for non-video signal write is secured. Then, a minimum necessary first period S1 for preventing deficient write at the time of video signal write in the first period S1 is secured. Thereafter, the remaining time in the 4-horizontal cycle period is divided into three, and assigned to the second periods S2, S3 and S4.

An alternative setting method is as follows. As regards an input video signal format with a highest horizontal frequency, that is, as regards an input video signal format with a least sum of the non-video signal write period K and video signal write period S, the non-video signal write period K and the first and second periods S1 to S4 are determined by the above-described method. As regards an input video signal format with a lower horizontal frequency, that is, as regards an input video signal format with a large sum of the non-video signal write period K and video signal write period S, the increased portion of the time width is equally assigned (i.e. in units of 1/5) to the non-video signal write period K and first and second periods S1 to S4, thus increasing each time width.

Even in the above-described case where the time width Ts1 of the first period S1, which follows the non-video signal write period K, is set to be greater than the time width Ts of the second period, S2 to S4, the timing controller TCNT controls, as shown in FIG. 2, the gate driver DGL and source driver DSL so that the four rows of display pixels PX are driven in units of a predetermined time length T in the first and second periods S1 to S4 which are assigned to these pixels PX.

In short, the timing controller TCNT controls the gate driver DGL so as to make equal the time length, in which the video signals Vp are written in one row of display pixels PX, between the first period S1 and each of the second periods S2 to S4.

In the example shown in FIG. 3 and FIG. 4, the gate lines GL1 to GL4 are successively selected in association with the first and second periods S1 to S4 of the video signal write period S, and the video signals Vp are written in the associated display pixels A to D. Since intermediate-gradation-level solid display is executed in this embodiment, the source line potential transitions from the black level to the intermediate gradation voltage level in the first period S1 that follows the non-video signal write period K. In the first period S1, the video signal Vp is written in the display pixel A.

At this time, if the time width Ts1 of the first period S1 is set to be greater than the time width Ts of the second period, S2 to S4, even if the time constant of the source line SL is large, the video signal Vp can be written in the associated display pixel A after the source line potential reaches the target potential within the first period S1. Thus, the voltage, which is written in the display pixel A, has the value of the target potential, and no write error occurs.

For example, in the case where a substantially equal voltage is applied to the SLk during the video signal write period S, if the time widths of the first period S1 and second periods S2 to S4 are made equal, the potential of the source line SLk is yet to reach the target value at the timing when the display pixel A is driven in the first period S1. As a result, a difference in write potential occurs between the display pixel A and the other display pixels B, C and D.

In particular, in the case of the liquid crystal display device of this embodiment, the non-video signals Vbk are simultaneously written in the four rows of display pixels PX in the non-video signal write period K. If a write error occurs in the display pixel PX in which the video signal Vp is written in the first period S1 following the non-video signal write period K, a horizontal stripe appears on the screen in every four rows.

By contrast, if the time width Ts1 of the first period S1 is set to be greater than the time width Ts of the second period, S2 to S4, as described above, the display pixel A is driven after the potential of the source line SLk reaches the target value, even in the case where the intermediate-gradation-level voltage is applied to the source line SLk during the video signal write period S.

Thus, no difference occurs between the potential that is written in the display pixel A and the potential that is written in the display pixel B, C, D. Therefore, no horizontal stripe appears on the screen in every four rows.

As has been described above, according to the driving method of the liquid crystal display device relating to the present embodiment, the occurrence of a signal write error in the display pixel PX is suppressed in the first period S1 that immediately follows the non-video signal write period. Thereby, a driving method of a display device, which displays a high-quality display image, can be provided.

Even in the case of the above-described driving in which the time width Ts1 of the first period S1, which is immediately after the non-video signal write period K, is set to be greater than the time width Ts of each of the second periods S2 to S4, the timing controller TCNT controls the gate driver DGL and source driver DSL so as to drive the display pixels A, B, C and D in units of a predetermined time length T in the first and second periods S1 to S4 of the video signal write period S, which are assigned to the display pixels A, B, C and D.

Thereby, even if deficient pixel write occurs, the degree of deficiency becomes equal between the display pixels A, B, C and D, and the retained voltage level also becomes equal. Thus, no horizontal stripe appears on the screen with a pitch of every four rows.

For example, in the case where the timing controller TCNT does not control the gate driver DGL and source driver DSL so as to drive the display pixels A, B, C and D in units of a predetermined time length T in the first and second periods S1 to S4 of the video signal write period S which are assigned to the display pixels A, B, C and D, if only the period of driving of the display pixel A is made greater than the period of driving of the display pixel B, C, D, it may be possible that the pixel potential does not reach the equilibrium state in the period of driving of the display pixel B, C, D.

In such a case, deficient write of the video signal Vp in the display pixel B, C, D occurs, and the charging of pixel potential progresses to a level closer to the equilibrium state during the period of driving of the display pixel A, which is a period with a longer effective write time. At last, the potential level that is held in the display pixel A differs from the potential levels of the other display pixels B, C and D.

By contrast, in the case where the timing controller TCNT controls the gate driver DGL and source driver DSL so as to drive the display pixels A, B, C and D in units of a predetermined time length T in the first and second periods S1 to S4 of the video signal write period S which are assigned to the display pixels A, B, C and D, even if pixel write deficiency occurs, the degree of deficiency is equal between the display pixels A, B, C and D. Thus, even in such a case, no horizontal stripe appears on the screen with a pitch of four rows.

In general, the OCB liquid crystal has a high liquid crystal material dielectric constant, and thus the pixel capacitance increases. As a result, pixel write deficiency tends to occur. In particular, the dielectric constant becomes higher in a low-temperature environment (0° C. or below). Thus, in the OCB liquid crystal, the above-described method, in which the effective write times of the pixel gates are made equal, is effective.

As has been described above, according to the liquid crystal display device and the driving method of the liquid crystal display device relating to the present embodiment, the occurrence of a signal write error in the display pixel PX in the first period S1, which immediately follows the non-video signal write period, is suppressed. It is possible, therefore, to provide a display device which displays a high-quality display image and a driving method of the display device.

Next, a liquid crystal display device according to a second embodiment of the invention and a driving method thereof are described. The structural parts common to those of the liquid crystal display device of the first embodiment are denoted by like reference numerals, and a description thereof is omitted.

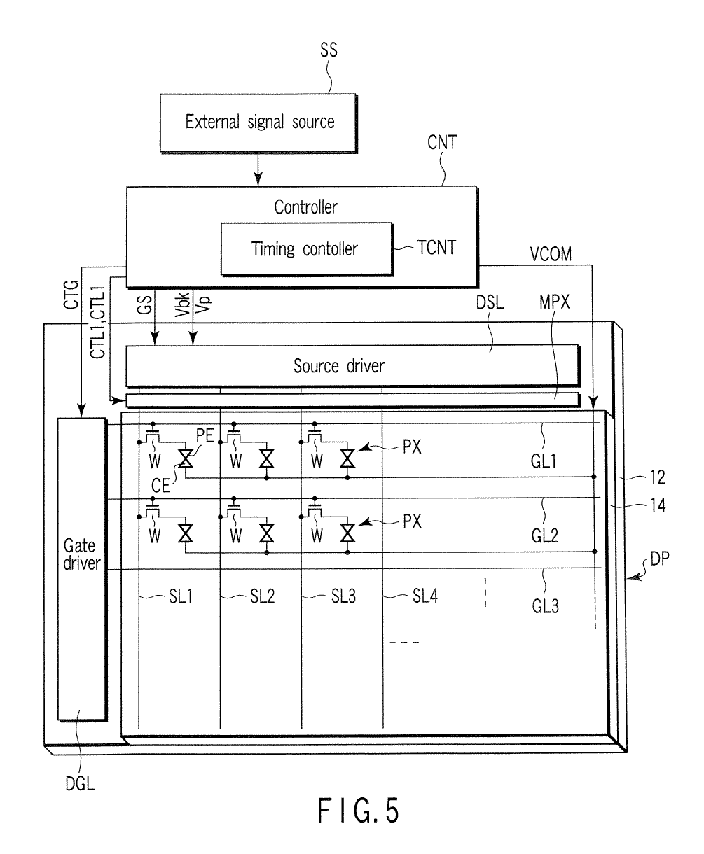

As is shown in FIG. 5, the liquid crystal display panel DP of the liquid crystal display device according to this embodiment further includes a multiplexer circuit MPX which is a switch circuit for distributing non-video signals Vbk and video signals Vp to associated ones of a plurality of rows of display pixels PX. The source driver DSL is connected to the source lines SL via the multiplexer circuit MPX.

The controller CNT includes a timing controller TCNT which controls the operation timings of the gate driver DGL, source driver DSL and multiplexer circuit MPX in each period of driving of the predetermined number of rows of display pixels.

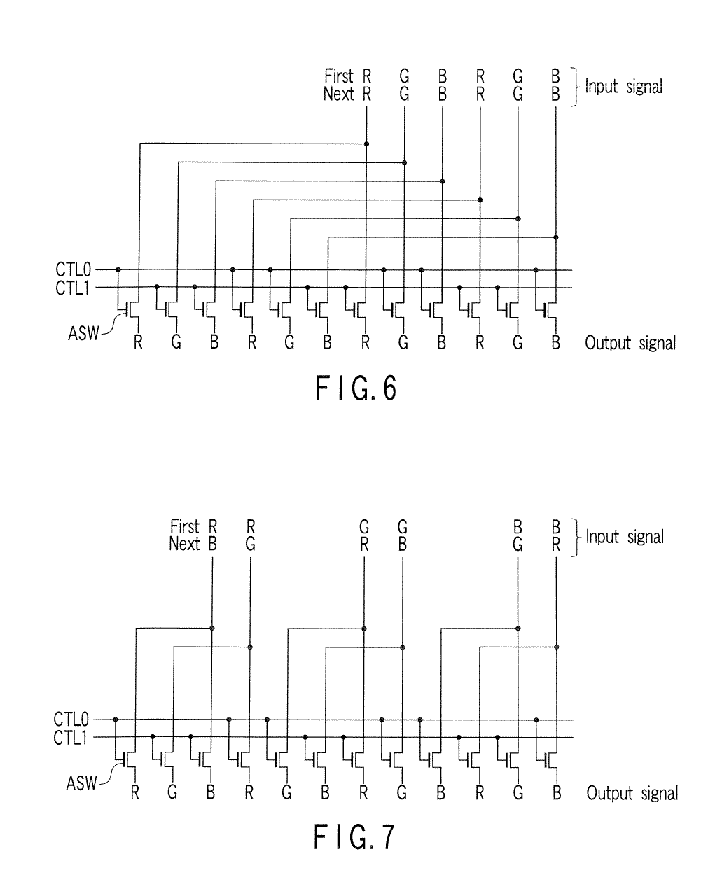

The multiplexer circuit MPX may adopt, for example, a scheme in which video signals are distributed between source lines of the same color and same polarity in a 12-column-cycle connection structure as shown in FIG. 6, or a scheme in which video signals are distributed in a 4-column-cycle structure as shown in FIG. 7. The multiplexer circuit MPX includes a plurality of analog switches ASW. In this embodiment, the multiplexer circuit MPX includes two analog switches ASW which distribute signals from the output buffer of the source driver DSL to two source lines.

The gate voltage of one of the two analog switches ASW is controlled by a control signal CTL0 which is input from the timing controller TCNT. The gate voltage of the other analog switch ASW is controlled by a control signal CTL1 which is input from the timing controller TCNT. In short, the video signal Vp, which is output from the output buffer Bf of the source driver DSL, is distributed to two source lines SL. At this time, the video signal Vp which corresponds to each source line SL is distributed by the control signals CTL0 and CTL1.

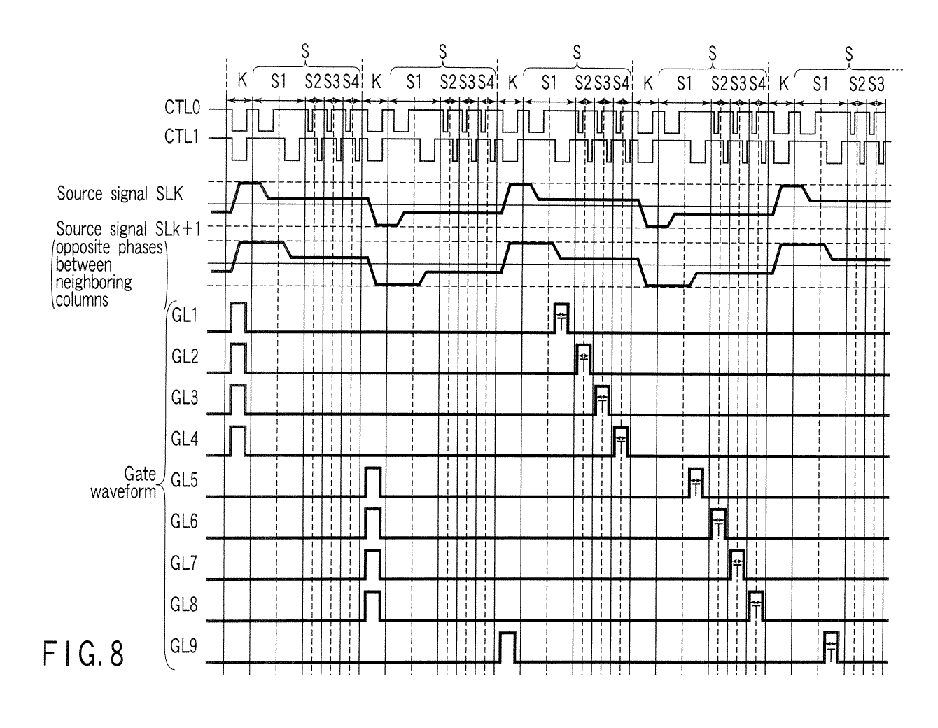

In an example shown in FIG. 8, the output buffer Bf of the source driver DSL is connected to source lines SLk and SLk+1 via the analog switches ASW of the multiplexer circuit MPX. The source line SLk is connected to the source electrodes of the pixel switches W of display pixels A to D, and the source line SLk+1 is connected to the source electrodes of the pixel switches W of display pixels E to H.

The analog switches ASW are controlled by the control signals CTL0 and CTL1. Specifically, when the control signal CTL0 is in the on-state, the analog switch ASW that is connected to the source line SLk is turned on, and the non-video signal Vbk and video signal Vp, which are output from the output buffer Bf, are written in the selected display pixel from the source line SLk via the display switch W that is connected to the selected gate line.

When the control signal CTL1 is in the on-state, the analog switch ASW that is connected to the source line SLk+1 is turned on, and the non-video signal Vbk and video signal Vp, which are output from the output buffer Bf, are written in the selected display pixel from the source line SLk+1 via the display switch W that is connected to the selected gate line.

With the provision of the above-described multiplexer circuit MPX, the same advantageous effect as with the first embodiment is obtained, and further the number of output buffers Bf of the source driver DSL can be decreased. Therefore, the cost can be reduced.

In the liquid crystal display device of this embodiment, as is shown in FIG. 8, the gate driver DGL and source driver DSL are configured to repeat the following operation. Specifically, in a non-video signal write period K, a plurality of gate lines GL are selectively driven so as to simultaneously select a predetermined number of rows of display pixels PX (in this embodiment four rows of display pixels PX), and non-video signals Vbk for the predetermined number of rows of display pixels PX are output as pixel voltages Vs to the plural source lines SL.

In a video signal write period S that follows the non-video signal write period K, the gate lines GL are selectively driven so as to successively select the predetermined number of rows of display pixels PX (in this embodiment four rows of display pixels PX), and video signals Vp for the predetermined number of rows of display pixels PX are output as pixel voltages Vs to the source lines SLk, SLk+1.

In the liquid crystal display device of this embodiment, too, the controller CNT, which controls the gate driver DGL and source driver DSL, assigns a first period S1 of the video signal write period S to the row of display pixels which are first driven, and successively assigns second periods S2 to S4 to the other rows of display pixels. The first period S1 is set to be longer than the second period, S2 to S4. In the video signal write period S, the predetermined number of rows of display pixels PX are driven in units of a predetermined time length T in the first and second periods S1 to S4 which are assigned to these display pixels PX.

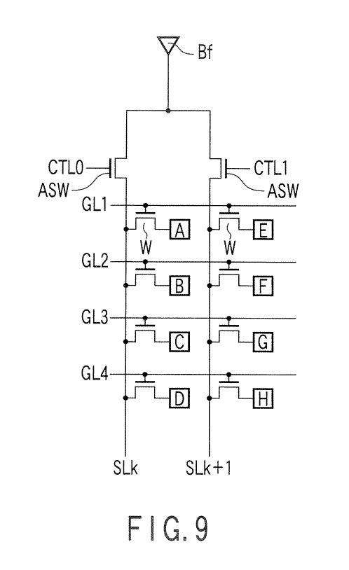

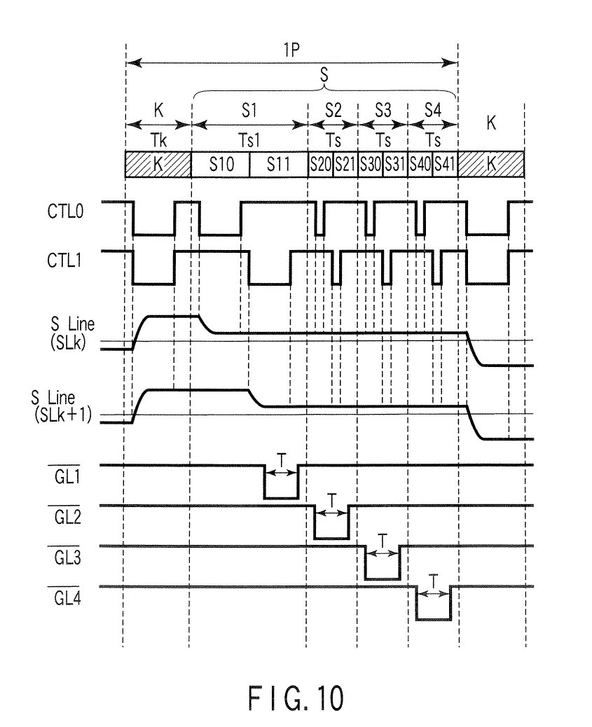

In this embodiment, each of the first and second periods S1 to S4 of the video signal write period S is divided into a first-half period and a second-half period. In an example shown in FIG. 9 and FIG. 10, the first period S1 is divided into a first-half period S10 and a second-half period S11. Similarly with the first period S1, each of the second periods S2 to S4 is divided into a first-half period and a second-half period.

In the first-half period of each of the first period S1 and second periods S2 to S4, the video signal Vp is applied to the source line SLk. In the second-half period of each of the first period S1 and second periods S2 to S4, the video signal Vp is applied to the source line SLk+1.

Even in the case where each of the first period S1 and second periods S2 to S4 is divided into the first-half period and second-half period, the first period S1 is set to be longer than each of the second periods S2 to S4. Thereby, the video signal Vp can be written in the display pixel PX in the first period S1 after the potential of the source line SLk, SLk+1 reaches the target value.

Thus, in the first period S1, the occurrence of a signal write error in the display pixel PX can be suppressed. According to the liquid crystal display device relating to the present embodiment, the occurrence of a signal write error in the display pixel PX is suppressed in the first period S1 that immediately follows the non-video signal write period. Thereby, a display device, which displays a high-quality display image, can be provided.

Next, a driving method of the above-described liquid crystal display device is described. In the description of this embodiment, like the first embodiment, it is assumed that video signals Vp have equal intermediate gradation levels in all the display pixels PX. The controller CNT controls the operation timing of the multiplexer circuit MPX, source driver DSL and gate driver DGL in every basic cycle (1P).

Specifically, as shown in FIG. 8, the gate driver DGL selectively drives the plural gate lines GL so as to simultaneously select a predetermined number of rows of display pixel PX in the non-video signal write period K. The source driver DSL outputs non-video signals Vbk, which correspond to the predetermined number of rows of display pixels PX, as pixel voltages Vs to the plural source lines SL. The pixel voltages Vs are applied to the display pixels PX of the selected rows via the associated pixel switches W.

In the video signal write period S that follows the non-video signal write period K, the gate driver DGL selectively drives the plural gate lines GL so as to successively select the predetermined number of rows of display pixels PX. The source driver DSL successively outputs video signals Vp, which correspond to the predetermined number of rows of display pixels PX, as pixel voltages Vs to the plural source lines SL. The pixel voltages Vs for one row are applied to the display pixels PX of the selected row via the associated pixel switches W.

In the present embodiment, each of the first and second periods S1 to S4 of the video signal write period S is further divided into a first-half period and a second-half period. In the example shown in FIG. 9 and FIG. 10, the first period S1 is divided into a first-half period S10 and a second-half period S11. In the first-half period S10, the control signal CTL0 is set in the on-state and the video signal Vp is applied to the source line SLk. In the second-half period S1, the control signal CTL1 is set in the on-state and the video signal Vp is applied to the source line SLk+1. At this time, the gate line GL1 is turned on, and the video signal Vp is written in the display pixel A, E via the multiplexer circuit MPX.

Like the first period S1, each of the second periods S2 to S4 is assigned to the first-half period and second-half period. The control signal CTL0 is set in the on-state in the first-half period, and the control signal CTL1 is set in the on-state in the second-half period. Thus, the video signal Vp is distributed to the source lines SLk and SLk+1.

In the first-half period S10 and second-half period S11, the source line potential transitions from the black level to the intermediate gradation level. In the first-half and second-half periods (S20, S21, S30, S31, S40, S41) of the second periods S2 to S4, the voltage level remains substantially the same. If a write error occurs only in the first-half period S10 and second-half period S11, the potentials written in the associated display pixels A and E have values different from the potentials written in the other display pixels B, C, D, F, G and H.

In this case, the time width Ts1 of the first period S1, which is immediately after the non-video signal write period K, is set to be greater than the time width Ts of each of the second periods S2 to S4. In the case of this driving, the write time of the multiplexer circuit MPX (the time in which the control signal CTL0, CTL1 is in the on-state) can be increased in the first period S1. Therefore, the occurrence of a horizontal stripe on the screen due to a source line write error can be suppressed.

As shown in FIG. 10, if the time width Ts1 of the first period S1 is set to be greater than the time width Ts of the second period, S2 to S4, the gate line GL1 can be driven after the potential of the source line SLk, SLk+1 reaches the target potential.

Like the first embodiment, by making equal the time lengths T for driving of the display pixels PX of one row in the first and second periods S1 to S4, the occurrence of a horizontal stripe on the screen due to a pixel write error can be suppressed.

In the example shown in FIG. 9 and FIG. 10, a substantially equal intermediate-gradation potential is applied to the display pixels A to H. At this time, in the first period S1 shown in FIG. 10, if the time length T for driving the display pixels A and E of one row is made greater than the time length T for driving the other display pixels, a difference occurs between the potential that is written in the display pixel A, E and the potential that is written in the other display pixels. As a result, a horizontal stripe occurs on the screen.

By contrast, by making substantially equal the time lengths T for driving of the display pixels PX of one row in the first and second periods S1 to S4, the potentials written in the display pixels A to H become substantially equal, and the occurrence of a horizontal stripe on the screen can be suppressed.

As has been described above, according to the liquid crystal display device of the present embodiment and the driving method thereof, like the above-described first embodiment, the occurrence of a signal write error in the display pixel PX is suppressed in the video signal write period that immediately follows the non-video signal write period. Thereby, a display device, which displays a high-quality display image, and a driving method of the display device can be provided.

In order to independently vary the horizontal cycle as described above, the display device should preferably include a timing controller TCNT which can freely control the on/off timing of the multiplexer circuit MPX and pixel switches W and the video signal variation start timing, by using the original 4 horizontal cycles of video input signals as a reference unit.

In general, in the scheme in which (n+1) division of an n-horizontal cycle period is executed, the display device should preferably include a timing controller TCNT which can freely set the timing by using the original n-horizontal cycles of video input signals as a reference unit.

The present invention is not limited directly to the above-described embodiments. In practice, the structural elements can be modified without departing from the spirit of the invention. For example, the analog switch 2-selection switching has been described. The invention is similarly applicable to 3-selection switching, 4-selection switching, etc. The liquid crystal mode is not limited. The invention is applicable to liquid crystal modes of TN, MVA, IPS, PVA, ASV, etc., as well as the OCB mode.

In the above-described driving, five write operations are executed in the 4-horizontal-cycle period. Compared to ordinary driving without black insertion, scanning is executed at a 5/4=1.25 times higher speed. Thus, this driving is called 1.25×driving. Variations of this driving scheme include a scheme in which a 2-horizontal-cycle period is divided by three (3/2=1.5×speed), and a scheme in which a 1-horizontal-cycle period is divided by two (2/1=2×speed).

In general, a scheme in which an n-horizontal-cycle period (n=natural number) is divided by (n+1) [(n+1)/n×speed] can be thought. As the value n increases, the 1-horizontal-cycle period after the division can be increased. Thus, from the standpoint of write, it is desirable to increase the value n. Although the case of n=4 is described, the value n is not limited to n=4 and the invention is applicable to switching with n=1, 2, 3, 4, 5, 6, . . . .

Each of the second periods S2 to S4 is relatively smaller than the first period S1. However, as far as solid display is executed in the second periods S2 to S4, no variation occurs in the source line potential, and the probability of a write error does not increase. In the case where no solid display is executed, the second periods S2 to S4 may be set to be different from each other in accordance with video signals which are written in the source lines SL.

Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A display device comprising:
a plurality of rows of display pixels;
a driver circuit which drives the plurality of rows of display pixels in units of a predetermined number of rows; and
a control circuit which controls the driver circuit in such a manner as to alternately execute non-video signal write for simultaneously driving the predetermined number of rows of display pixels and writing non-video signals, and video signal write for successively driving the predetermined number of rows of display pixels and writing video signals,
wherein the control circuit assigns, in the video signal write, a first period to the row of display pixels which are first driven, and a second period to each of the other rows of display pixels, and sets the first period to be longer than the second period.

2. The display device according to claim 1, wherein in the video signal write, the predetermined number of rows of display pixels are driven in units of a predetermined time length in the first and second periods which are assigned to the display pixels.

3. The display device according to claim 1, wherein the control circuit includes a timing controller which controls an operation timing of the driver circuit in each period in which the predetermined number rows of display pixels are driven.

4. The display device according to claim 1, further comprising a switch circuit which distributes the non-video signals and the video signals to associated display pixels of the plurality of rows of display pixels.

5. The display device according to claim 4, wherein the control circuit includes a timing controller which controls operation timings of the driver circuit and the switch circuit in each period in which the predetermined number rows of display pixels are driven.

6. The display device according to claim 1, wherein each of the display pixels is an OCB liquid crystal pixel.

7. A driving method of a display device including a plurality of rows of display pixels; a driver circuit which drives the plurality of rows of display pixels in units of a predetermined number of rows; and a control circuit which controls the driver circuit in such a manner as to alternately execute non-video signal write for simultaneously driving the predetermined number of rows of display pixels and writing non-video signals, and video signal write for successively driving the predetermined number of rows of display pixels and writing video signals, the method comprising:
causing the control circuit to assign, in the video signal write, a first period to the row of display pixels which are first driven, and a second period to each of the other rows of display pixels; and
causing the control circuit to set the first period to be longer than the second period.

8. The driving method of a display device, according to claim 7, wherein the control circuit controls, in the video signal write, the driver circuit such that the predetermined number of rows of display pixels are driven in units of a predetermined time length in the first and second periods which are assigned to the display pixels.

9. The driving method of a display device, according to claim 7, wherein the display device further includes a switch circuit which distributes the non-video signals and the video signals, which are output from the driver circuit, to associated display pixels of the plurality of rows of display pixels, and the control circuit controls operation timings of the driver circuit and the switch circuit in each period in which the predetermined number rows of display pixels are driven.
